(19) United States
(12) Patent Application Publication
(10) Pub. No.: US 2016/0362041 A1
(43) Pub. Date: Dec. 15, 2016

(54) ACCESSORY MOUNT SYSTEM FOR UTILITY TERRAIN VEHICLES

(71) Applicant: SILENT DRIVE, INC., Orange City, IA (US)

(72) Inventors: Mark E. DeJong, Hospers, IA (US); Walter W. Oliver, Granville, IA (US)

(21) Appl. No.: 14/739,749

(22) Filed: Jun. 15, 2015

(51) Int. Cl. B60P 7/08; B62D 33/02; B60R 9/06

(52) U.S. Cl. CPC B60P 7/0815; B60R 9/06; B62D 33/02

(57) ABSTRACT

An improved system for anchoring objects to a flatbed area of a vehicle is provided. The system includes a deck surface comprised of plurality of elongated guide rails and a plurality of slotted rails disposed on the flatbed area. The guide rails and the slotted rails can be interchangeable. The system can include a storage receptacle having opposing sidewalls. At least one of the opposing sidewalls has a channel. A clamp assembly can include a first locking member and a second locking member configured to anchor the storage receptacle to the deck surface. The first locking member can be disposed within the slot of the slotted rails and the second locking member can be disposed within the channel of the one of the opposing sidewalls of the storage receptacle. The clamp assembly can be selectively orientable.

### FIELD OF THE DISCLOSURE

The present disclosure relates generally to anchoring objects. More particularly, but not exclusively, the present disclosure relates to a system and method for anchoring cargo and/or accessory items to deck surfaces of vehicles such as utility terrain vehicles, all-terrain vehicles, and pick-up trucks.

### BACKGROUND OF THE DISCLOSURE

Due to the versatility of utility terrain vehicles (UTVs) and all-terrain vehicles (ATVs), the vehicles are utilized in a variety of applications. The applications range from light-duty, work-related use by farmers and other laborers when heavier machinery is unnecessary, to recreational uses for outdoor enthusiasts for various sport and leisure activities. Both work-related and recreational uses often are associated with transporting cargo and/or accessories. For example, a laborer might wish to securely transport tools in one or more toolboxes. Similarly, a recreational hunter may wish to safely transport firearms in gun cases and/or a hunting dog in a dog box. To that end, UTVs and pick-up trucks, and to a lesser extent ATVs, have a flatbed area.

Current systems and methods to secure and transport cargo and/or accessories to the flatbed area of a UTV or pick-up truck are cumbersome and ineffective. For example, one product commonly used is bungee cords. The elastic cords with hooks on each end are secured to an accommodating structure of the flatbed area. Often, however, the flatbed area and/or the cargo itself does not have a suitable structure (e.g., a loop) to secure the hook of the bungee cord. If suitable structures are present, they are typically associated with the edges or walls of the flatbed area. In such instances, the center area of the flatbed area is underutilized. Further, bungee cords typically are not designed to support heavier and/or larger cargo. Still further, multiple bungee cords are often needed to support an object in multiple directions.

Another product commonly used is a ratchet tie-down system. While designed to support heavier loads than bungee cords, the ratchet tie-down systems have several similar shortcomings. The systems require an accommodating structure of the flatbed area. The belt of the ratchet tie-down system effectively compresses the object to the flatbed area, potentially leaving an object prone to slidably disengaging from the anchoring system. Still further, objects of different heights each require its own ratchet tie-down system, as a belt compressing a taller object will not be able to provide suitable compression to an adjacent smaller object. Therefore, a need exists in the art for an improved anchoring system and method that is capable of anchoring heavier and larger cargo and maximizing the storage area of the flatbed without requiring accommodating structures associated with the wall of the flatbed area.

The shortcomings associated with bungee cords, ratchet tie-down systems, and other commonly used anchoring systems are exacerbated by the demanding terrain often traversed by UTVs, ATVs, and pick-up trucks. For example, climbing rugged terrain or rapidly descending into a gulley can dislodge objects secured with deficient anchoring systems. Therefore, a further need exists in the art for an improved anchoring system and method that effectively secures cargo and/or accessories in demanding off-road terrain.

Based on the broad scope of potential applications, many UTV, ATV and pick-up truck owners desire that the flatbed area can be reconfigured to the needed application with minimal time and effort. For example, an individual may wish to quickly remove a toolbox and add a gun cases and/or dog box. For another example, an individual may wish to efficiently reorient the cargo and/or accessories in the flatbed area to maximize space. Therefore, a need exists in the art for improved anchoring system and method that is easily configurable to add, remove and/or replace cargo and/or accessories.

### SUMMARY OF THE DISCLOSURE

It is therefore a primary object, feature, and/or advantage of the present disclosure to improve on or overcome the deficiencies in the art.

It is another object, feature, and/or advantage of the present disclosure to provide an anchoring system capable of anchoring heavier, larger, and/or oddly-shaped objects.

It is yet another object, feature, and/or advantage of the present disclosure to maximize the deck surface of the flatbed area available for transporting cargo and/or accessories. The improved anchoring system of the present disclosure does not require accommodating structures associated with the wall of the flatbed area.

It is still yet another object, feature, and/or advantage of the present disclosure to effectively secure cargo and/or accessories in demanding off-road terrain.

It is another object, feature, and/or advantage of the present disclosure to provide an anchoring system in which cargo and/or accessories can be quickly and efficiently added, removed and/or replaced.

These and/or other objects, features, and advantages of the present disclosure will be apparent to those skilled in the art. The present disclosure is not to be limited to or by these objects, features and advantages. No single embodiment need provide each and every object, feature, or advantage.

According to an aspect of the disclosure, a system for anchoring objects such as accessory items to a flatbed area of a vehicle is provided. The system includes a plurality of guide rails disposed on the flatbed area and comprising a portion of a deck surface. A plurality of slotted rails is also disposed on the flatbed area and comprising another portion of the deck surface. Each of the slotted rails has a slot. The system can include a storage receptacle having opposing sidewalls. At least one of the opposing sidewalls has a channel. A clamp assembly can include a first locking member and a second locking member. The clamp assembly can be configured to anchor the storage receptacle to the deck surface. The first locking member can be disposed within the slot of the slotted rails and the second locking member can be disposed within the channel of the one of the opposing sidewalls of the storage receptacle. The second locking member can be selectively orientable parallel or perpendicular to the slot of the slotted rails. At least one elongated slotted rails can positioned between two of the guide rails. The guide rails and the slotted rails can be interchangeable.

Each of the guide rails and each of the slotted rails can have at least one interlocking member opposite the support member. At least one interlocking member is configured to create an interference fit with an adjacent support member associated with one of the guide rails or one of the slotted rails.

According to another aspect of the disclosure, a system for anchoring objects such as accessory items to a flatbed area of a vehicle includes a plurality of guide rails and a plurality of slotted rails parallel to the guide rails. Each of the guide rails comprises an upper portion, a support portion extending from the upper portion and configured to be secured to the flatbed area, and an interlocking portion extending from the upper portion opposite the support portion. Each of the slotted rails comprises an upper portion, a support portion extending from the upper portion and configured to be secured to the flatbed area, an interlocking portion extending from the upper portion opposite the support portion, and a slot disposed within the upper portion. The system includes a deck surface comprising the upper portions of the guide rails and the slotted rails. The interlocking portions of the guide rails and the slotted rails can configured to create an interference fit with the support portions of the guide rails or the slotted rails. A storage receptacle can rest upon the deck surface and can be anchored to at least one of the slotted rails.

The system can further include a clamping assembly having a first clamping portion configured to lock with a slot associated with one of the slotted rails; and a second clamping portion configured to lock with a channel associated with a sidewall of the storage receptacle. The storage receptacle can be configured to be selectively oriented and secured parallel or perpendicular to a direction of the slots associated with the slotted rails. Further, an arrangement of the guide rails and the slotted rails is selectively configurable.

According to yet another aspect of the disclosure, a cargo and accessory anchoring system for UTV's is provided. A UTV flatbed deck surface has a plurality of guide rails and spaced apart T-shot rails each adopted to allow an accessory item to sit on the top of the guiderails. A clamp assembly can allow the accessory item to be locked to the flatbed deck surface at any desired location on the guide rails by locking to the accessory item and the flatbed deck surface through clamping to T-slots in each.

According to still yet another aspect of the disclosure, an ATV comprises a chassis, a cab supported by the chassis, a deck assembly supported by the chassis, and an ATV flatbed deck surface. The deck assembly has a flatbed deck surface. The deck surface has a plurality of guide rails and T-slots each adopted to allow at least one accessory item to sit on the guide rails. A clamp assembly can allow the at least one accessory item to be locked to the flatbed deck surface at a desired location along the guide rails.

According to another aspect of the disclosure, a method for anchoring objects to a flatbed area of a vehicle is provided. The method comprises the step of securing a support member of an elongated guide rail to the deck surface. An interlocking portion of an elongated slotted rail is positioned adjacent to the support member of the elongated guide rail. The interlocking portion can be shaped and configured to create an interference fit with the support member. A support member of the elongated slotted rail is secured to the deck surface. A storage receptacle can be positioned on a deck surface comprising an upper portion of the elongated guide rail and an upper portion of the elongated slotted rail. A first portion of a clamping assembly can be connected to a slot extending longitudinally along the elongated slotted rail. A second portion of the clamping assembly can be connected to a channel associated with the storage receptacle.

### BRIEF DESCRIPTION OF THE DRAWINGS

Illustrated embodiments of the disclosure are described in detail below with reference to the attached drawing figures, which are incorporated by reference herein, and where:

FIG. 1 is a perspective view of a UTV in accordance with an illustrative embodiment;

FIG. 2 is a perspective view of a deck surface of an anchoring system in accordance with an illustrative embodiment;

FIG. 3 is a side elevation view of a slotted rail in accordance with an illustrative embodiment;

FIG. 4 is a side elevation view of a guide rail in accordance with an illustrate embodiment;

FIG. 5 is a side elevation view of a deck surface, storage receptacle, and clamp assemblies in accordance with an illustrative embodiment;

FIG. 6A is a detailed view of the deck surface, storage receptacle, and clamp assemblies of FIG. 3 within circle 6A-6A;

FIG. 6B is a side elevation view of a storage receptacle in accordance with an illustrative embodiment;

FIG. 7 is a detailed view of the deck surface and clamp assembly of FIG. 3 within circle 7-7;

FIG. 8A is a perspective view of a clamp assembly in accordance with an illustrative embodiment;

FIG. 8B is a side elevation view of a clamp assembly in accordance with an illustrative embodiment;

FIG. 9A is a side elevation view of an interlocking member of a storage receptacle in accordance with an illustrative embodiment;

FIG. 9B is a side elevation view of an interlocking member of a storage receptacle in accordance with an illustrative embodiment;

FIG. 9C is a side elevation view of an interlocking member of a storage receptacle in accordance with an illustrative embodiment;

FIG. 9D is a side elevation view of an interlocking member of a storage receptacle in accordance with an illustrative embodiment; and

FIG. 9E is a side elevation view of an interlocking member of a storage receptacle in accordance with an illustrative embodiment.

### DETAILED DESCRIPTION

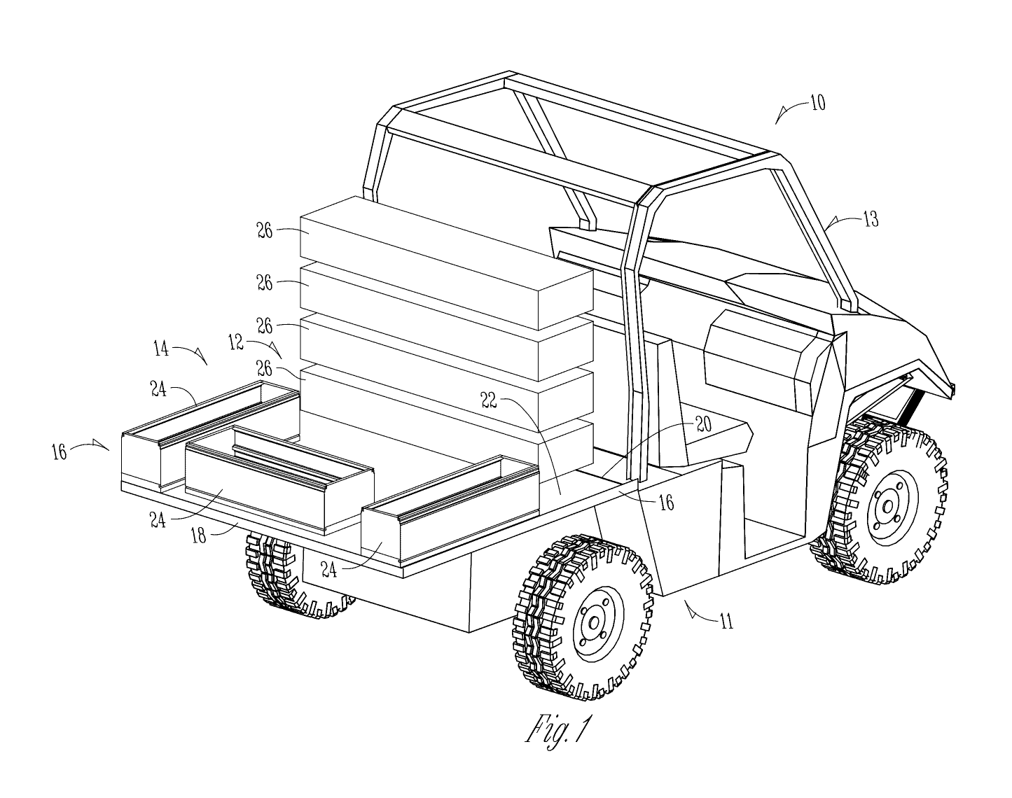

FIG. 1 illustrates an exemplary vehicle 10 with which an anchoring system 12 of the present disclosure can be implemented. The vehicle 10 includes a flatbed area 14 having opposing side edges 16, a rear edge 18 opposite a front edge 20, and a top surface 22. In the exemplary embodiment of FIG. 1, three toolboxes 24 and four gun cases 26 are secured to the flatbed area 14 of the vehicle 10. Any size, type, number, and/or shape of the cargo, accessories, and/or other objects may be secured without deviating from the objects of the present disclosure. The present disclosure further contemplates that while a UTV having a chassis 11 and a cab 13 is illustrated in FIG. 1, the anchoring system 12 can be installed on a flatbed area of any suitable vehicle, including but not limited to ATVs, pick-up trucks, flatbed transporters, and the like.

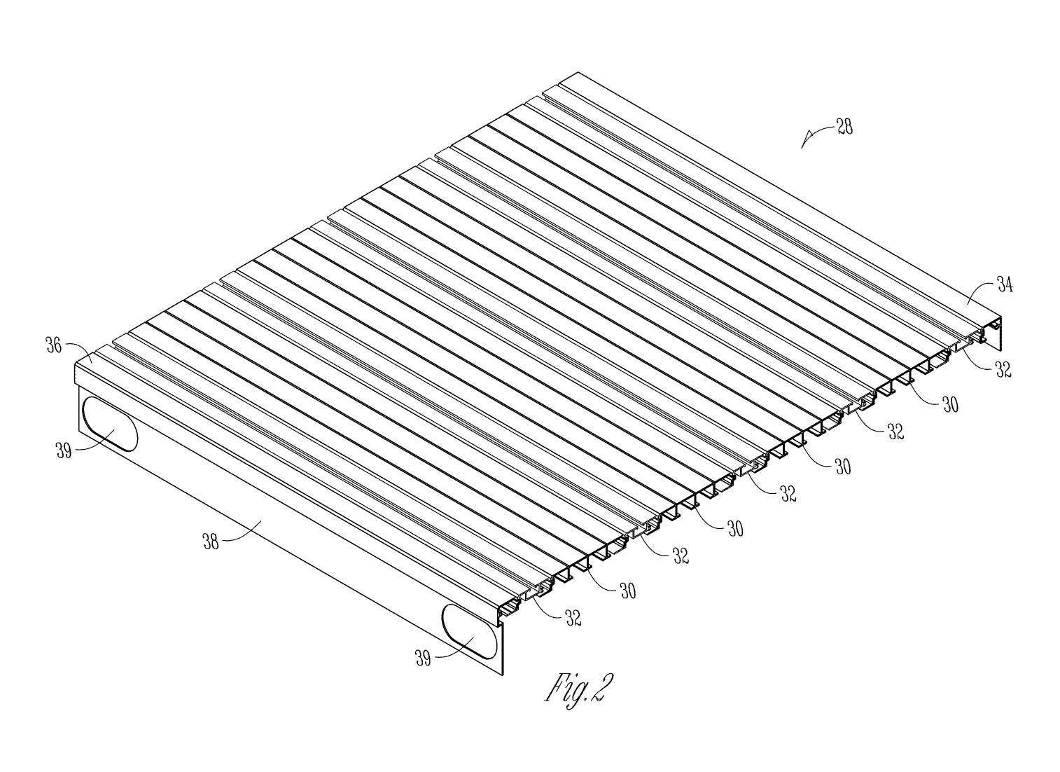

Referring to FIG. 2, a deck surface 28 in accordance with an exemplary embodiment is illustrated. The deck surface 28 can be comprised of a plurality of guide rails 30 and a plurality of slotted rails 32. The plurality of guide rails 30 and the plurality of slotted rails 32 can be bookended by a front end rail 34 positioned proximate to the front edge 20 of the vehicle 10, and a rear end rail 36 positioned proximate to the rear edge 18 of the vehicle 10. The rear end rail 36 can include a downwardly extending flange 38 with openings 39 for taillights of the vehicle 10. In the illustrated embodiment of FIG. 2, the plurality of guide rails 30, the plurality of slotted rails 32, the front end rail 34, and the rear end rail 36 are elongated. The rails can be of any length and or width without deviating from the objects of the present disclosure. The plurality of slotted rails 32 are oriented parallel to the plurality of guide rails 30. In a preferred embodiment, the plurality of guide rails 30 and the plurality of slotted rails 32 extend between opposing side edges 16 within the flatbed area 14 of the vehicle 10, a configuration illustrated in FIG. 2. In another exemplary embodiment, the plurality of guide rails 30 and the plurality of slotted rails 32 can extend between the rear edge 18 and the front edge 20 within the flatbed area 14 of the vehicle 10, a configuration perpendicular to the embodiment illustrated in FIG. 2.

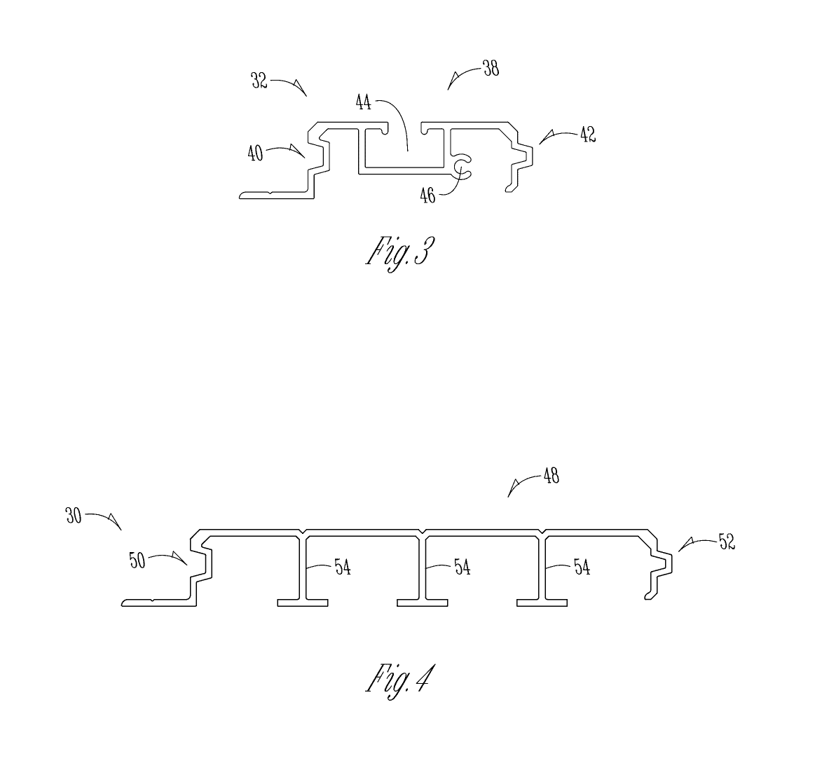

A side elevation view of an exemplary slotted rail 32 is illustrated in FIG. 3. The slotted rail 32 can include an upper portion 38, an interlocking portion 40 extending from the upper portion 38, and a support portion 42 extending from the upper portion 38 on a side opposite the interlocking portion 40. In the illustrated exemplary embodiment of FIG. 3, the interlocking portion 40 and the support portion 42 extend downwardly, creating a three-sided structure. A slot 44 can be associated with the slotted rail 32, and more particularly, disposed within the upper portion 38. As illustrated in FIG. 3, the slot 44 extends downwardly into the upper portion 38 and is T-shaped. The slot 44 serves as the primary connective means for the clamping assembly, which will be discussed in detail below. A C-shaped member 46 can be associated with the slotted rail 32, and more particularly the slot 44. The C-shaped member 46 can be used to connect side panels (not shown) to the deck surface 28 after installation of the anchoring system 12 on the vehicle 10. The side panels can keep out debris and precipitation from the underside of the deck surface 28 and/or serve aesthetic purposes.

FIG. 4 shows a side elevation view of an exemplary guide rail 30. Similar to the slotted rail 32, the guide rail 30 can include an upper portion 48, an interlocking portion 50 extending from the upper portion 48, and a support portion 50 extending from the upper portion 48 on a side opposite the interlocking portion 50. In the illustrated embodiment of FIG. 4, the interlocking portion 50 and the support portion 50 extend downwardly. Further, the guide rail 30 can include one or more support legs 54. The support legs 54 can extend downwardly from the upper portion 48 to help support the weight of the objects secured to the deck surface 28.

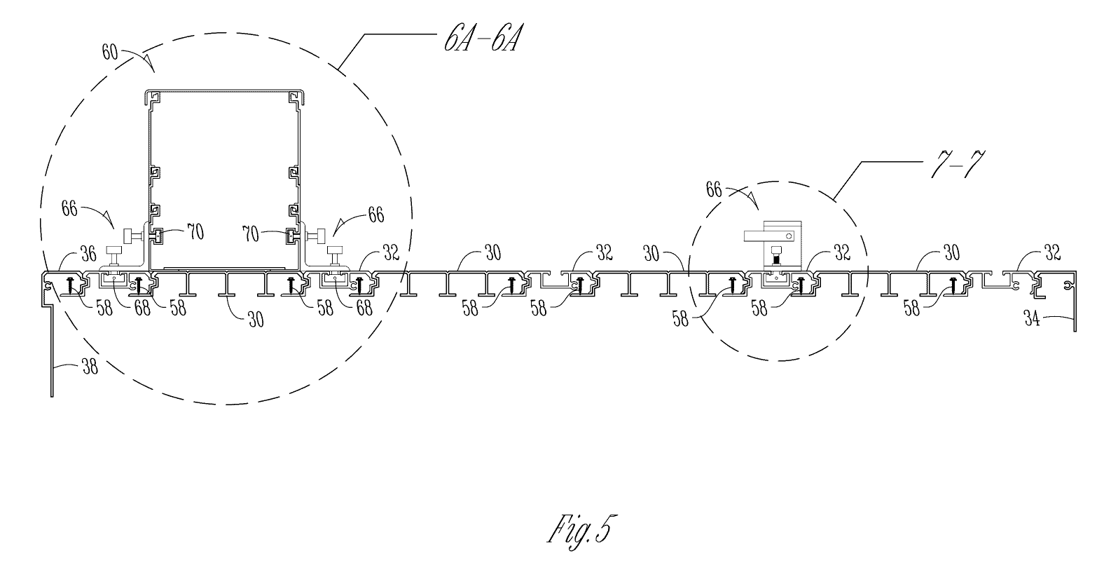

In an exemplary embodiment illustrated in FIGS. 3 and 4, the interlocking portions 40, 50 and the support portions 42, 52 are rectilinear. Based on their advantageous design, the arrangement of the plurality of guide rails 30 and the plurality of slotted rails 32 is selectively configurable. That is, the shape of the interlocking portions 40, 50 of both the guide rails 30 and the slotted rails 32 is configured to create an interference fit with an adjacent support portion 42, 52 associated with guide rail 30 or a slotted rail 32. Thus, the guide rails 30 and slotted rails 32 can be interchangeable and/or arranged in any configuration. In the illustrated embodiment of FIGS. 2 and 5, the plurality of guide rails 30 and the plurality of slotted rails 32 are arranged in an alternating fashion. As shown in FIG. 2, the arrangement results in the slotted rails 32 being equally spaced between the front edge 20 and the rear edge 18 of the vehicle 10. In another exemplary embodiment, the deck surface 28 can be comprised only of slotted rails 32, resulting in additional slots 44 with which to anchor objects. In still another exemplary embodiment, two guide rails 30 can be spaced between every slotted rail 32. The present disclosure contemplates any number, order and/or arrangement of the guide rails 30 and the slotted rails 32 without deviating from the objects of the present disclosure. Yet despite their complex designs, the consistent cross sections of the slotted rails 32 and the guide rails 30 permit the rails to be formed by extrusion or other similar manufacturing means, resulting in simplified, cost-effective fabrication. In an exemplary embodiment, the guide rails 30 and/or the slotted rails 32 can be composed of aluminum, but the present disclosure contemplates any type of metal, plastic, and/or polymer of suitable rigidity and strength.

The plurality of guide rails 30 and the plurality of slotted rails 32 can comprise the deck surface 28. More specifically, the upper portion 38 of the slotted rails 32 and the upper portion 48 of the guide rails 30 can comprise a top surface of the deck surface 28. In an exemplary embodiment illustrated in FIG. 2, the top surface of the deck surface 28 is substantially planar.

To install the deck surface 28 on or within the flatbed area 14 of the vehicle 10, a guide rail 30 or a slotted rail 32 is joined against a front end rail 34. For the purposes expressed herein, the term “joined” includes positioning the interlocking portion of a rail (i.e., guide rail or slotted rail) adjacent to a support portion of another rail such that the convexity of the interlocking portion abuts the concavity of the support portion, referenced generally as 56 of FIG. 7. In the exemplary embodiment illustrated in FIG. 5, a slotted rail 32 is joined with the front end rail 34. The support portion 40 of the slotted rail 32 is secured to the flatbed area 14 of the vehicle 10 with a screw 58 or other fastening device such as a bolt, clamp, pin, weld, and the like. The steps are effectively repeated, wherein another guide rail 30 or slotted rail 32 are joined with the rail previously joined. In the exemplary embodiment illustrated in FIG. 5, a guide rail 30 is joined with the slotted rail 32 previously installed. A screw 58 or other fastening device can secure the support portion 50 of the guide rail 30. In such an installation method, only one fastening member 58 is associated with each of the rails 30, 32. The configuration advantageously minimizes the number of fastening members secured to the flatbed area of the vehicle 10. The steps are repeated until a desired deck surface 28 is installed. A rear end rail 38 can be joined with the guide rail 30 or slotted rail 32 proximate to the rear edge 18 of the vehicle 10. A side elevation view of an exemplary deck surface 28 is illustrated in FIG. 5.

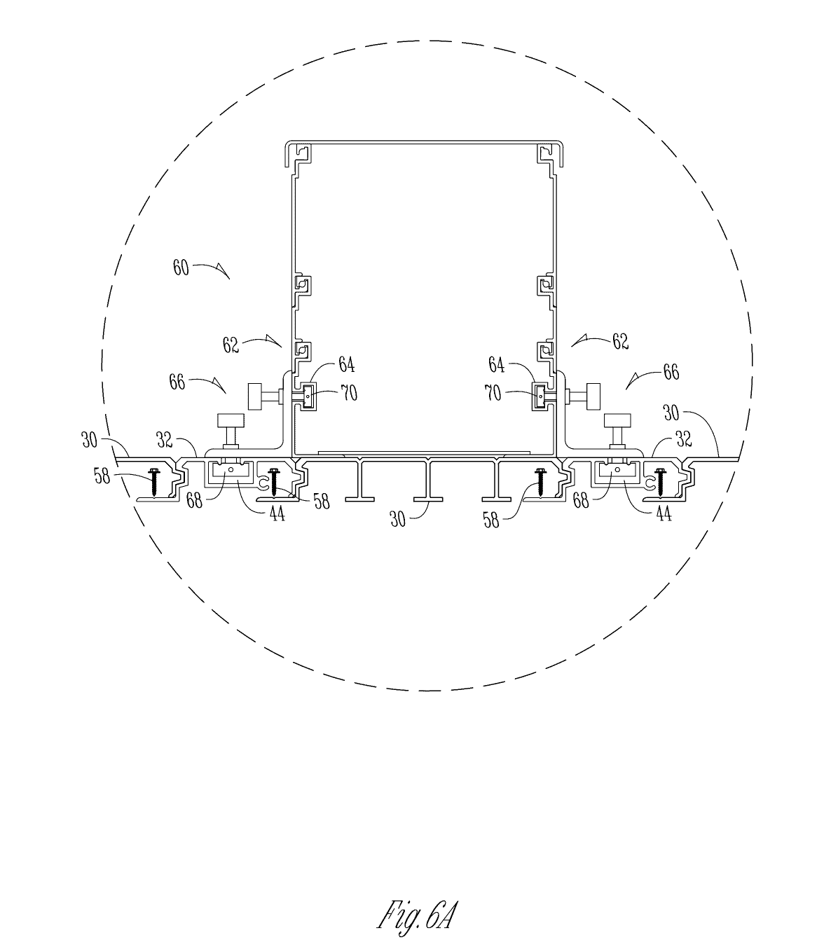

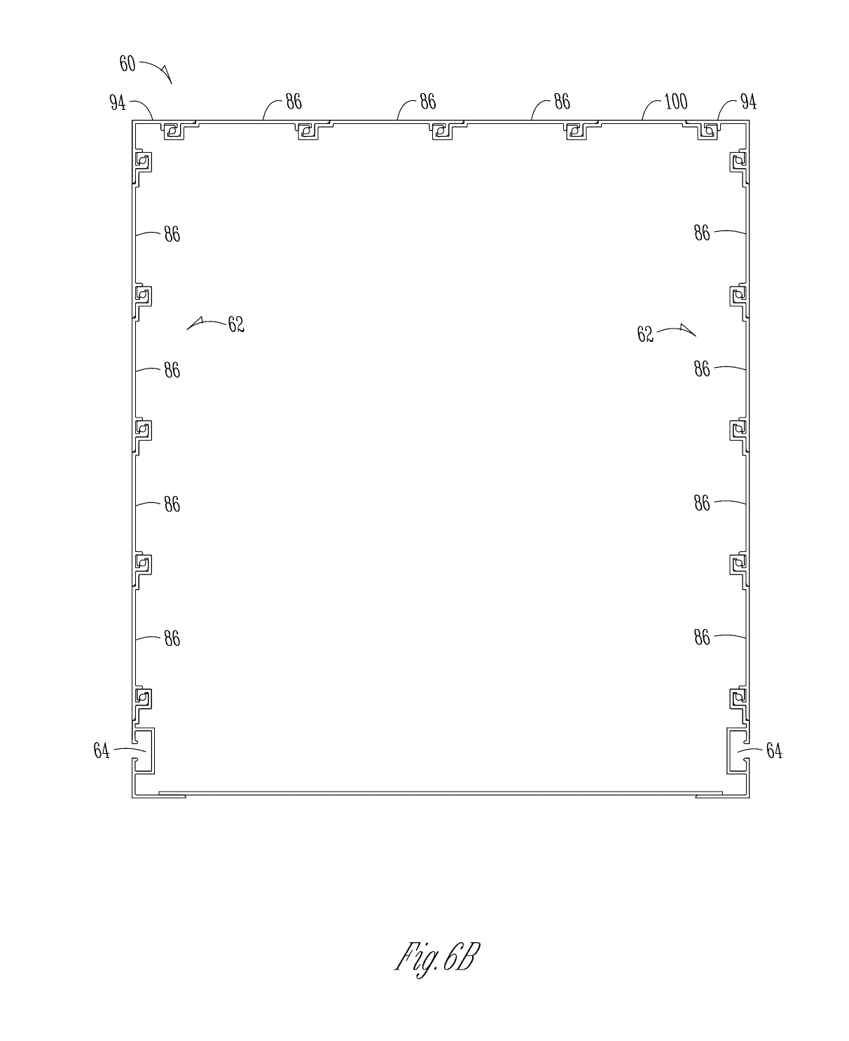

An object of the present disclosure is to secure cargo and/or accessories to a vehicle. Referring to FIGS. 5, 6A and 6B, a storage receptacle 60 can be secured to the deck surface 28. The storage receptacle 60 can be a toolbox 24 and/or gun case 26, as illustrated in FIG. 1, or any other type of container without deviating from the objects of the present disclosure. An exemplary storage receptacle 60 can include a bottom wall, opposing sidewalls 62, and a top wall. The storage receptacle 60 can be comprised of a plurality of interlocking components, which will be discussed in detail below. At least one of the opposing sidewalls 62 includes a channel 64. In the embodiment illustrated in FIGS. 6A and 6B, a channel 64 extends inwardly from a lower portion of each of the opposing sidewalls 62 of the storage receptacle 60.

A clamp assembly 66 secures the storage receptacle 60 to the deck surface 28. As illustrated in FIGS. 5 and 6A, the clamp assembly 66 can have a first locking member 68 (or first clamping portion) disposed within the slot 44 of the slotted rail 32 and a second locking member 70 (or second clamping portion) disposed within the channel 64 of an opposing sidewall 62 of the storage receptacle 60.

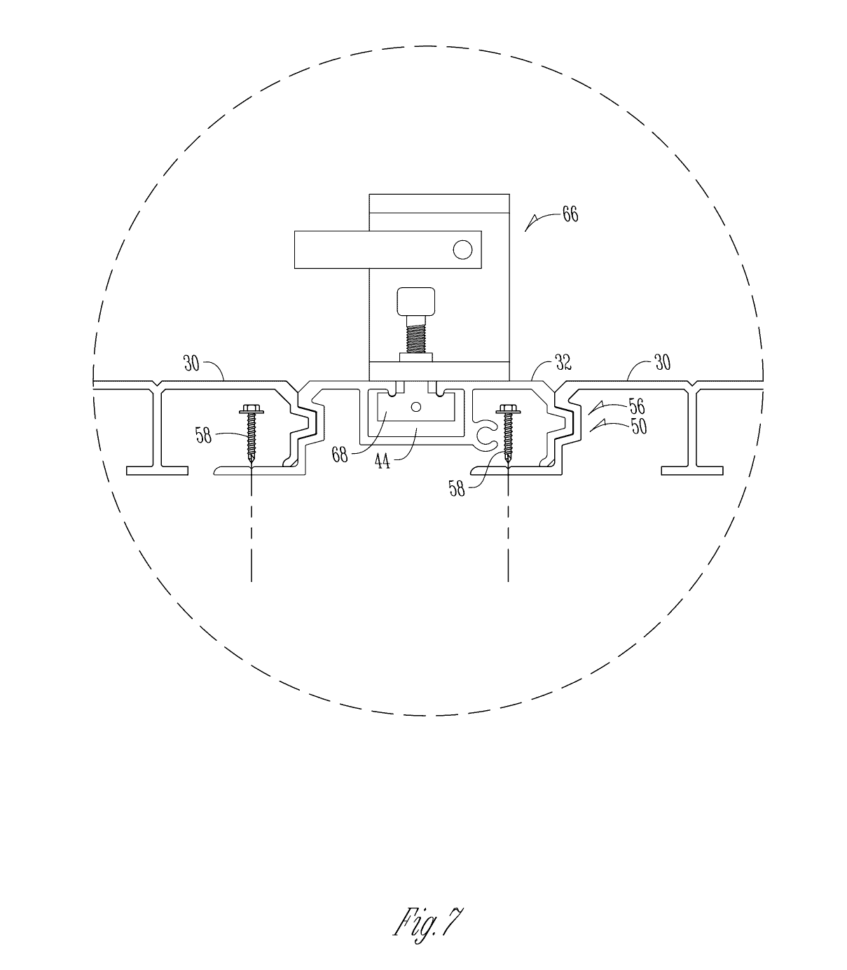

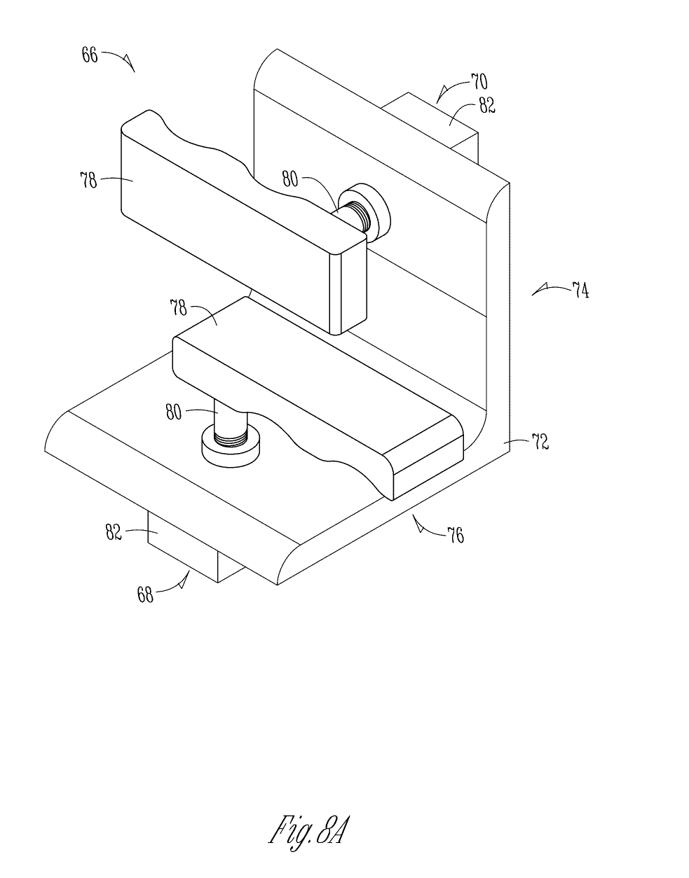

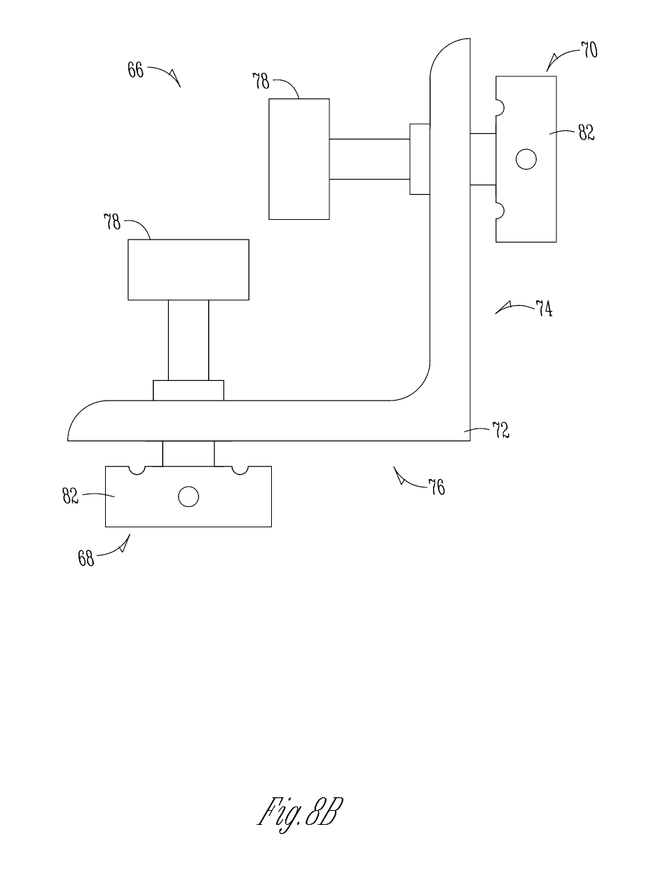

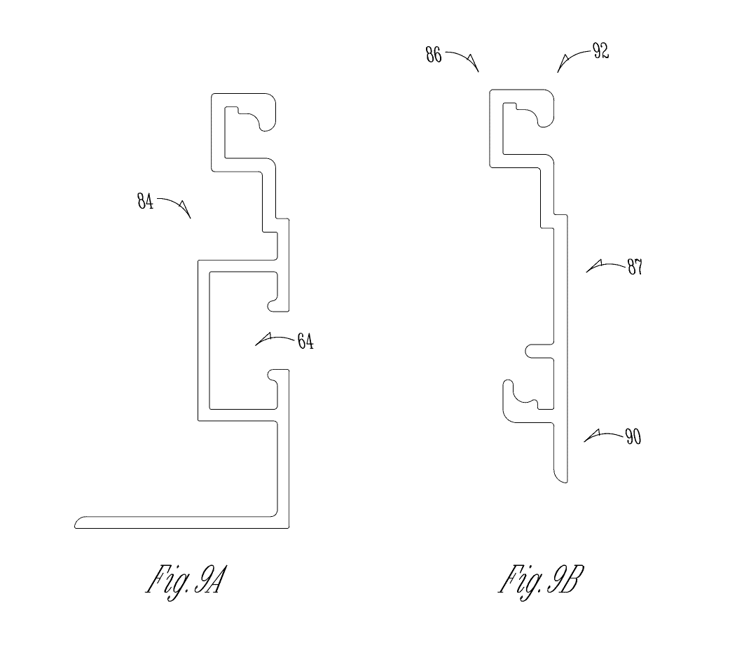

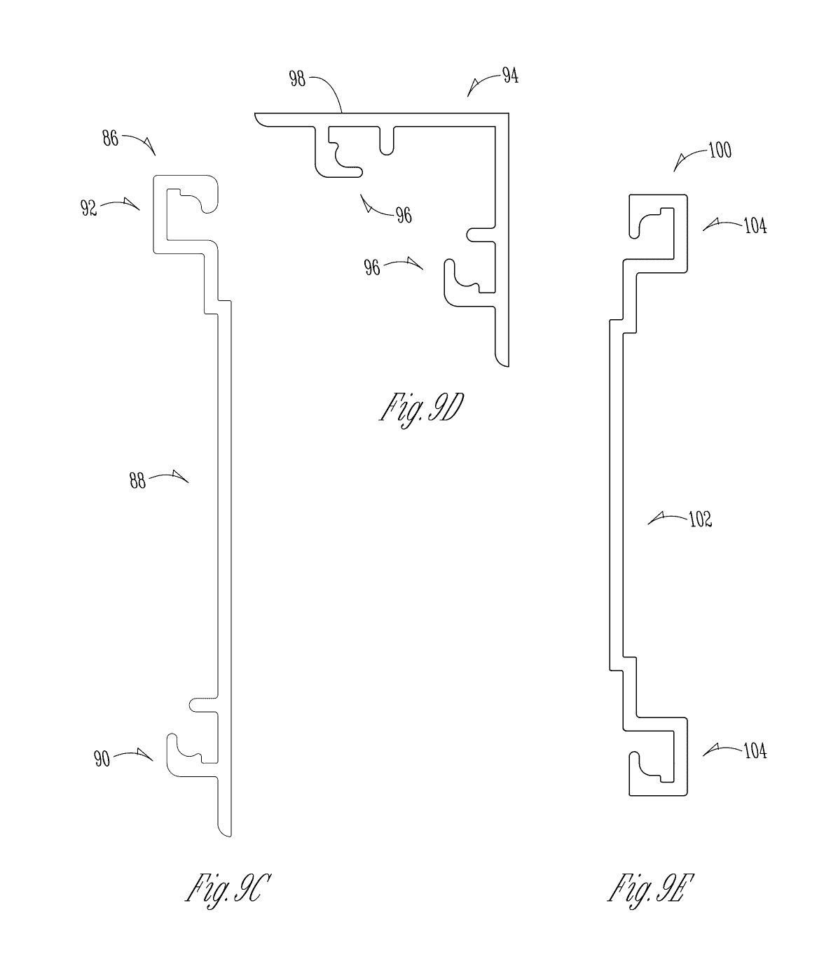

An exemplary embodiment of the clamp assembly 66 is illustrated in FIGS. 8A and 8B. The clamp assembly 66 can include a structural member 72 having two perpendicular portions 74, 76. The first locking member 68 can be operably connected to one 76 of the two perpendicular portions, and the second locking member 70 can be operably connected to another one 74 of the two perpendicular portions. The first locking member 68 and/or the second locking member 70 can be comprised of handles 78, shafts 80, springs (not shown), nuts (not shown) and clamping bodies 82. The combination of the handles 78, shafts 80 and springs can comprise a spring-loaded, quick-release clamp assembly 66, whereby turning the handle 78 for less than a full revolution fully locks the clamp assembly 66. The present disclosure also contemplates the clamp assembly 66 can comprise an over-the-center clamp, over-center toggle lock/latch, over-the-center draw latch, and the like.

The clamping bodies 82 are sized and shape so as to be inserted into the slot 44 of a slotted rail 32 and/or a channel 64 of an opposing sidewall 62 of the storage receptacle 60 in one direction, but to engage the slot 44 and/or the channel 64 in another direction. More specifically and with reference to FIGS. 6A and 8B, the clamping bodies 82 are rectangular prisms having a length greater than a width. The width of a clamping body 82 is less than the width of the slot 44 and/or the channel 64. The length of the clamping body 82, however, is greater than the width of the slot 44 and/or the channel 64. Thus, the clamping body 82 oriented to be inserted into the slot 44 and/or the channel 64 and rotated by ninety degrees, after which the clamping body 82 will not be removable without reorienting the clamping body 82. After the clamping body 82 is inserted and properly oriented, the clamping portion 68, 70 associated with the clamping body 82 can be tightened to secure the clamping assembly 66 to the deck surface 28 or the storage receptacle 60. As previously expressed, the handle 78 can be used to tighten the clamping portion 68, 70, but the present disclosure also contemplates other means for doing so. For example, a bolt may be present in lieu of a handle, after which a user tightens the bolt. The manner in which the clamping portions 68, 70 are tightened can be achieved through means commonly known in the art.

To summarize, a storage receptacle 60 is positioned on the deck surface 28. In a preferred embodiment, the storage receptacle 60 can be positioned on a guide rail 30 and can have a width substantially equal to that of the guide rail 30. In such an arrangement, the opposing sidewalls 62 of the storage receptacles are proximate to two slotted rails 32, as illustrated, for example, in FIG. 6A. This can permit each of the opposing sidewalls 62 of the storage receptacle 60 to be secured to the deck surface 28. A first portion 68 of the clamping assembly 66 is secured to a slotted rail 32 as previously expressed herein. A second portion 70 of the clamping assembly is secured to a channel 64 of the storage receptacle 60 as previously expressed herein.

Based on the design of the slotted rails 32 and clamping assemblies 66, the clamping assemblies 66 can be slidably positioned along the length of the slotted rail 32 and/or slidably positioned along the length of the channel 64 of the storage receptacle 60. Further, the clamping assemblies 66 can be oriented in multiple directions relative to the slotted rails 32. FIGS. 5 and 7 illustrate clamping assemblies 66 oriented in two directions. In FIG. 5, the clamping assemblies 66 associated with the storage receptacle 60 are perpendicular to the unattached clamping assembly 66. In short, the clamping assembly 66, and more particularly the second portion 74 of the same, can be selectively oriented parallel or perpendicular to the slot 44 of the slotted rail 32. Similarly, based on the desired orientation of the storage receptacle 60 on the deck surface 28, the channel 64 of the receptacle can be parallel, perpendicular or orthogonal to the slot 44 of one of the slotted rails 32. The advantageous design permits maximization of the storage capacity of the deck surface 28 of the anchoring system 12. Still further, the present disclosure contemplates multiple clamping assemblies 66 can be utilized along the depth of the storage receptacle 60 for increased anchoring capacity, which may be particularly useful when the vehicle 10 is traversing demanding terrain.

As mentioned above, the storage receptacles 60 can be comprised of a plurality of interlocking members. FIG. 6B illustrates an exemplary storage container 60 comprised of a plurality of interlocking members; and FIGS. 7A-7E illustrate a variety of exemplary interlocking members. Referring to FIGS. 6B and 7A, an exemplary interlocking member 84 having the channel 64 is illustrated. The interlocking member 84 will preferably be located proximate to the lower portion of the storage receptacle 60 in order to connect to the clamping assembly 66 as previously expressed herein. FIGS. 7B and 7C illustrate additional exemplary interlocking members 86. The interlocking members 86 of FIGS. 7B and 7C are the same, with the exception that a wall portion 87 of the interlocking member 86 of FIG. 7C is longer. In addition to the wall portion 87, the interlocking members 86 are comprised of a first connector 90 and a second connector 92. The first connector 90 and/or the second connector 92 can comprise a rectilinear structure, and more particularly, a generally three-sided rectilinear structure. However, the present disclosure contemplates the first connector 90 and/or the second connector 92 can comprise a curvilinear structure, and the like. In the illustrated exemplary embodiment of FIGS. 7B and 7C, the first connector 90 and the second connector 92 are oriented in opposing directions. Further, the second connector 92 is offset inwardly (i.e., towards the interior of the storage receptacle 60). The configuration permits multiple interlocking members 86 to be connected in series to create a storage receptacle 60 of a desired height. For example, the storage receptacle 60 illustrated in FIG. 6B can comprise a dog box. Alternatively, one or more interlocking members 86 can be removed to shorten the height of the storage receptacle 60, which may comprise a gun case, tool box, or other accessory, similar to those illustrated in FIG. 1.

Upon achieving a desired height of the storage receptacle, a corner interlocking member 94 can be connected to the uppermost interlocking member 86, as shown illustratively in FIG. 6B. An exemplary corner interlocking member 94 is illustrated in FIG. 7D. The corner interlocking member 94 can comprise two connectors 96 separated by a perpendicular wall structure 98. To close off the outer surface of the storage receptacle 60, a symmetric interlocking member 100 may be required. An exemplary symmetric interlocking member 100 is illustrated in FIG. 7E. The symmetric interlocking member 100 can comprise a wall portion 102 separating two connectors 104. In contrast to the interlocking member 86, the connectors 104 of the interlocking member 100 are oriented in the same direction and both offset from the wall portion 102. As illustrated in FIG. 6B, and more particularly the upper-right portion of the storage receptacle, the symmetric interlocking member 100 can connect to interlocking members with connectors oriented in the same direction. The function and design of interlocking members can provide unique versatility by permitting and individual control over the dimensions of the storage receptacle 60, in addition to the versatility and configurability of the overall anchoring system 12.

The disclosure is not to be limited to the particular embodiments described herein. In particular, the disclosure contemplates numerous variations in the type of ways in which embodiments of the disclosure can anchor cargo and/or accessory items to deck surfaces of vehicles such as utility terrain vehicles, all-terrain vehicles, and pick-up trucks. The foregoing description has been presented for purposes of illustration and description. It is not intended to be an exhaustive list or limit any of the disclosure to the precise forms disclosed. It is contemplated that other alternatives or exemplary aspects that are considered included in the disclosure. The description is merely examples of embodiments, processes or methods of the disclosure. It is understood that any other modifications, substitutions, and/or additions can be made, which are within the intended spirit and scope of the disclosure. For the foregoing, it can be seen that the disclosure accomplishes at least all that is intended.

The previous detailed description is of a small number of embodiments for implementing the disclosure and is not intended to be limiting in scope. The following claims set forth a number of the embodiments of the disclosure with greater particularity.

What is claimed is:

1. A system for anchoring objects to a flatbed area of a vehicle, the system comprising:
a plurality of elongated guide rails disposed on the flatbed area and comprising a portion of a deck surface;
a plurality of elongated slotted rails disposed on the flatbed area and comprising another portion of the deck surface, each of the plurality of elongated slotted rails having a slot;
a storage receptacle having opposing sidewalls, wherein at least one of the opposing sidewalls has a channel;
a clamp assembly having a first locking member and a second locking member, the clamp assembly configured to anchor the storage receptacle to the deck surface; and
wherein the first locking member is disposed within the slot of one of the plurality of elongated slotted rails and the second locking member is disposed within the channel of the one of the opposing sidewalls of the storage receptacle.

2. The system of claim 1 wherein at least one of the plurality of elongated slotted rails is positioned between two of the plurality elongated guide rails.

3. The system of claim 1 wherein the clamp assembly further comprises:
a structural member having two perpendicular portions;
wherein the first locking member is operably connected to one of the two perpendicular portions; and
wherein the second locking member is operably connected to another one of the two perpendicular portions.

4. The system of claim 3 wherein the second locking member is oriented vertically, and wherein the second locking member is selectively orientable parallel or perpendicular to the slot of the plurality of elongated slotted rails.

5. The system of claim 1 wherein the slots of each plurality of elongated slotted rails and the channel of the one of the opposing sidewalls are substantially T-shaped.

6. The system of claim 1 wherein the plurality of elongated guide rails and the plurality of elongated slotted rails create a substantially planar top surface configured to support the storage receptacle.

7. The system of claim 6 wherein the slot associated with each of the plurality of elongated slotted rails extends downwardly from the substantially planar top surface.

8. The system of claim 1 wherein the plurality of elongated guide rails and the plurality of elongated slotted rails are configured to be interchangeable.

9. The system of claim 1 wherein each of the plurality of elongated guide rails and each of the plurality of slotted rails have at least one rectilinear support member configured to be secured to the deck surface.

10. The system of claim 8 wherein each of the plurality of elongated guide rails and each of the plurality of slotted rails have at least one rectilinear interlocking member opposite the rectilinear support member, wherein the at least one rectilinear interlocking member is configured to create an interference fit with an adjacent rectilinear support member associated with one of the plurality of elongated guide rails or one of the plurality of elongated slotted rails.

11. The system of claim 1 wherein the storage receptacle further comprises a plurality of interlocking members configured to removably connected to and extend upwardly from the opposing sidewalls.

12. A system for anchoring objects to a flatbed area of a vehicle, the system comprising:
a plurality of guide rails, each of the plurality of guide rails comprising:
(a) an upper portion;
(b) a support portion extending from the upper portion and configured to be secured to the flatbed area;
(c) an interlocking portion extending from the upper portion opposite the support portion;
a plurality of slotted rails oriented parallel to the plurality of guide rails, each of the plurality of slotted rails comprising:
(a) an upper portion;
(b) a support portion extending from the upper portion and configured to be secured to the flatbed area;
(c) an interlocking portion extending from the upper portion opposite the support portion;
(d) a slot disposed within the upper portion;
a deck surface comprising the upper portions of the plurality of guide rails and the upper portions of the plurality of slotted rails;
wherein the interlocking portions of the plurality of guide rails and the interlocking portions of the plurality of slotted rails are configured to create an interference fit with the support portions of the plurality of guide rails or the support portions of the plurality of slotted rails;
wherein a storage receptacle rests upon the deck surface and anchored to at least one of the plurality of slotted rails.

13. The system of claim 12, further comprising:
a clamping assembly comprising:
(a) a first clamping portion configured to lock with the slot associated with one of the plurality of slotted rails; and
(b) a second clamping portion configured to lock with a channel associated with a sidewall of the storage receptacle.

14. The system of claim 13 wherein the first clamping portion and the second clamping portion are perpendicular.

15. The system of claim 13 wherein the storage receptacle is configured to be selectively oriented and secured parallel or perpendicular to a direction of the slots associated with the plurality of slotted rails.

16. The system of claim 12 wherein an arrangement of the plurality of guide rails and the plurality of slotted rails is selectively configurable.

17. The system of claim 13 wherein the channel associated with a sidewall of the storage receptacle is orthogonal to the slot associated with one of the plurality of slotted rails.

18. The system of claim 12 wherein the vehicle is a utility terrain vehicle.

19. A cargo and accessory anchoring system for UTV's, comprising:
a UTV flatbed deck surface;
said deck surface having a plurality of guide rails and spaced apart T-slot rails each adopted to allow an accessory item to sit on the top of the guiderails;
a clamp assembly to allow said accessory item to be locked to the flatbed deck surface at any desired location on the guide rails by locking to the accessory item and the flatbed deck surface through clamping to T-slots in each.

20. An all-terrain vehicle (ATV), comprising:
a chassis;
a cab supported by the chassis;
a deck assembly supported by the chassis having a flatbed deck surface;
said deck surface having a plurality of guide rails and T-slots each adopted to allow at least one accessory item to sit on the guide rails; and
a clamp assembly to allow the at least one accessory item to be locked to the flatbed deck surface at a desired location along the guide rails.
